(19) United States
(12) Patent Application Publication
(10) Pub. No.: US 2012/0173812 A1
(43) Pub. Date: Jul. 5, 2012

(54) METHOD AND SYSTEM FOR DATA DISTRIBUTION ACROSS AN ARRAY OF DRIVES

(75) Inventors: Kevin Kidney, Lafayette, CO (US); Kenneth J. Gibson, Lafayette, CO (US)

(73) Assignee: LSI CORPORATION, Milpitas, CA (US)

(21) Appl. No.: 12/982,430

(22) Filed: Dec. 30, 2010

(51) Int. Cl. G06F 12/00

(52) U.S. Cl. 711/114; 711/E12.001

(57) ABSTRACT

Methods and systems for data distribution may include, but are not limited to: receiving a request from a client device to store data on a distributed storage system; obtaining a hierarchical cluster map representing the distributed storage system; selecting an object at a hierarchical level of the cluster map; determining if the hierarchical level is a drive level; and adding a drive identifier associated with the object to a drive identifier array if the hierarchical level is the drive level.

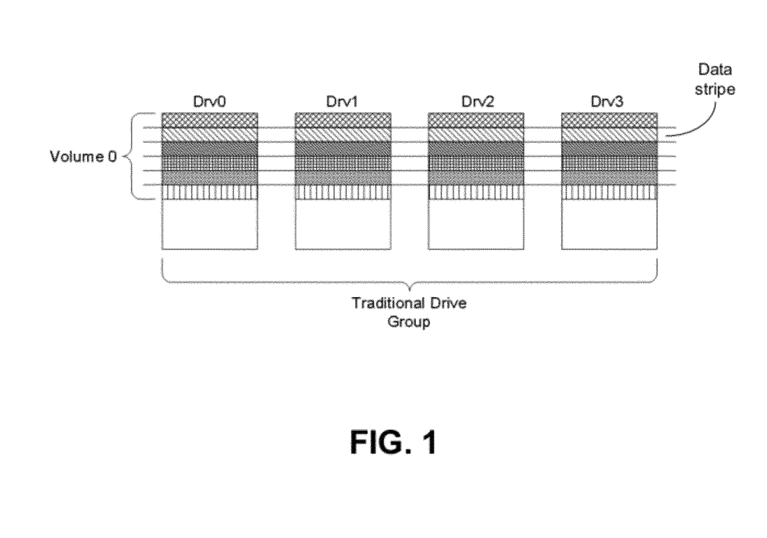

The traditional RAID data layout uses a fixed mapping to correlate host addressable blocks to their location on a physical drive in a RAID volume. As shown in FIG. 1, the traditional mapping defines a fixed group of drives where a RAID stripe occupies the same set of logical block addresses (LBAs) on every drive in the group. The number of drives in the group determines the width of the RAID stripe.

The performance of a RAID volume is limited by the number of drives in the group. The overall throughput of the volume is the aggregation of the overall throughput of each of the drives. A system may have 100 drives and if a volume is defined on a group of 10 drives (i.e. a RAID stripe is only 10 drives wide), then 90 of the drives cannot contribute to any I/O that is directed at the volume.

A drive failure within a drive group can have significant performance impacts because every RAID volume stripe is affected by the failed drive, so each stripe must be treated as degraded, which decreases performance.

Reconstructing the failed drive requires either a Hot Spare drive or a replacement drive for the failed drive. In either case, all of the data on the failed drive must be rebuilt and rewritten to the new drive in the group.

Reconstruction performance is limited by how fast data can be read from the remaining drives in the group and re-written to the new drive. This can be days or weeks when larger drives are used.

### SUMMARY OF INVENTION

Methods and systems for data distribution may include, but are not limited to: receiving a request from a client device to store data on a distributed storage system; obtaining a hierarchical cluster map representing the distributed storage system; selecting an object at a hierarchical level of the cluster map; determining if the hierarchical level is a drive level; and adding a drive identifier associated with the object to a drive identifier array if the hierarchical level is the drive level.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which FIGS:

1 illustrates a traditional data distribution;

2 illustrates a system for data distribution;

3 illustrates a system for data distribution;

4 illustrates a system for data distribution;

5 illustrates a system for data distribution;

6 illustrates a process for data distribution;

7 illustrates a system for data distribution;

8 illustrates a system for data distribution;

9 illustrates a system for data distribution;

### DETAILED DESCRIPTION

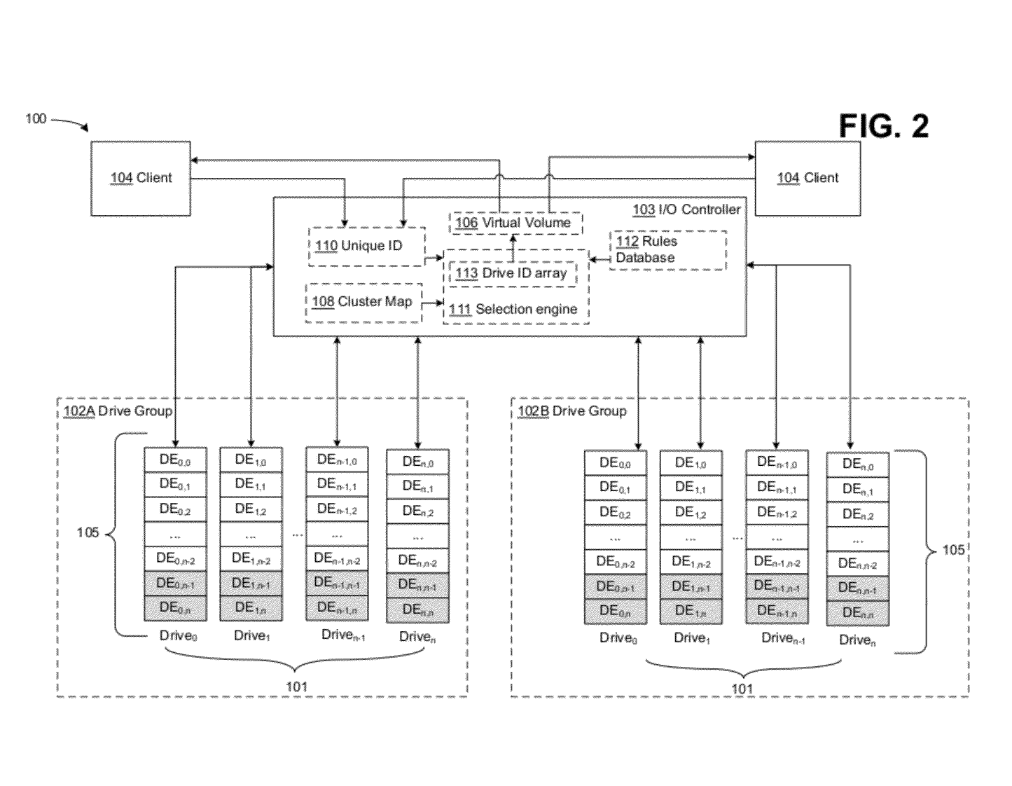

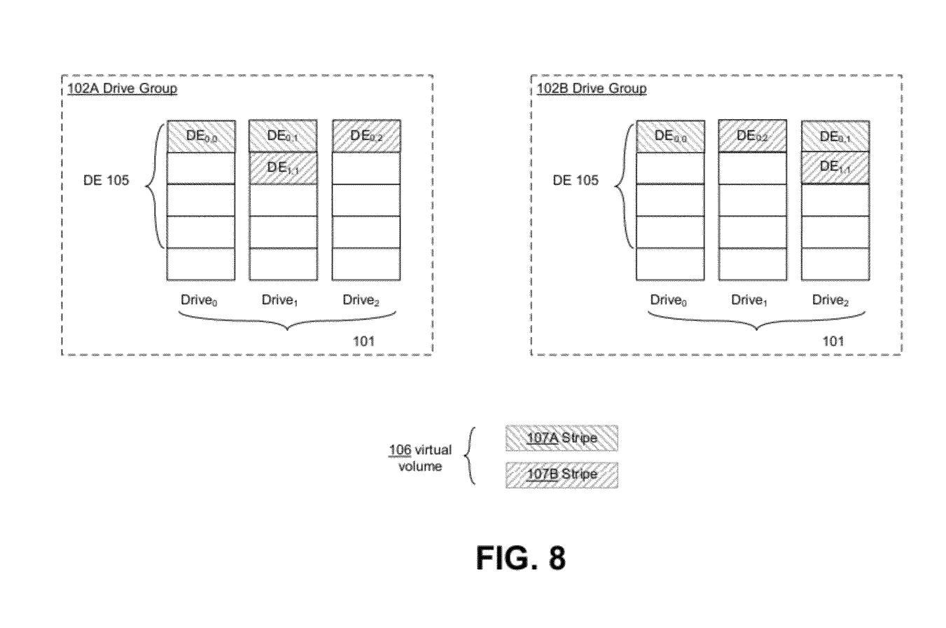

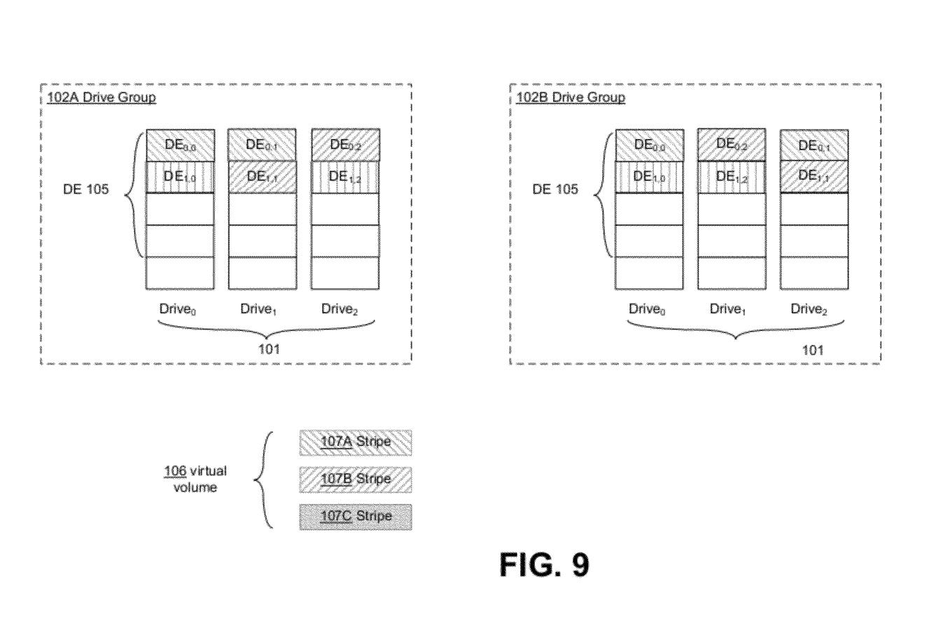

Reference will now be made in detail to the subject matter disclosed, which is illustrated in the accompanying drawings. Referring generally to FIGS. 2-9, the present disclosure is directed to systems and methods for data distribution across an array of drives.

As shown in FIG. 2, a distributed data storage system 100 is shown. For example, the system 100 may define a distribution of data across various drives 101 available in an m-drive group 102. A data distribution algorithm may serve to uniformly distribute data across a pool of storage in a pseudo-random, but repeatable, fashion. The distribution algorithm may be deterministic, which enables independent client nodes to each implement the same model and reach the same data distribution on a shared pool of storage. This allows data to be written or read by any node in a system and every node will locate the same data in the same place. The data allocation may be controlled by an I/O controller 103. The I/O controller 103 may receive data input/output commands from at least one client device 104 and execute those commands to store or retrieve data according to the algorithm. Exemplary data distribution algorithms may include, but are not limited to, the Controlled Replication Under Scalable Hashing system developed by the University of California at Santa Cruz as part of the Storage System Research Center as described in “CRUSH: Controlled, Scalable, Decentralized Placement of Replicated Data” by Weil et al. incorporated herein by reference in its entirety.

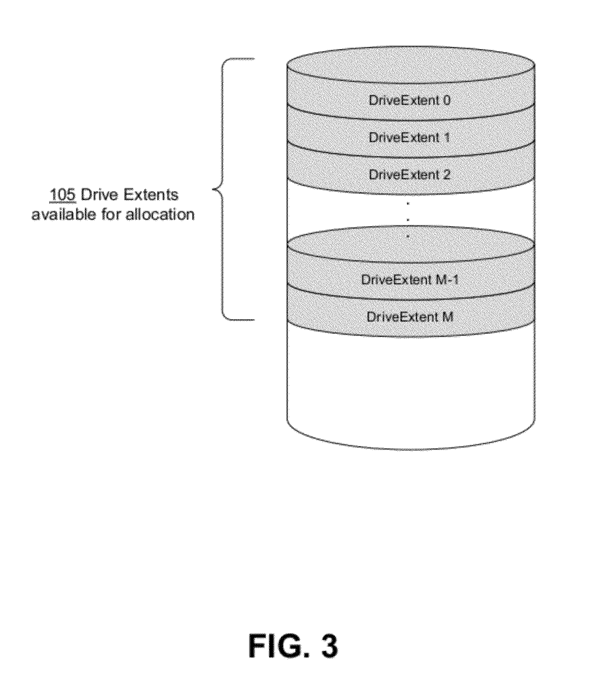

As shown in FIG. 3, a Drive Extent (DE) 105 may be a unit of allocation of drive space on a drive 101. The useable capacity of each drive may be divided up into such drive extents 105 (e.g. m drive extents 105). The size of the drive extents 105 may be dependent on the number of drives, drive capacity, and internal firmware and other implementation-dependent requirements.

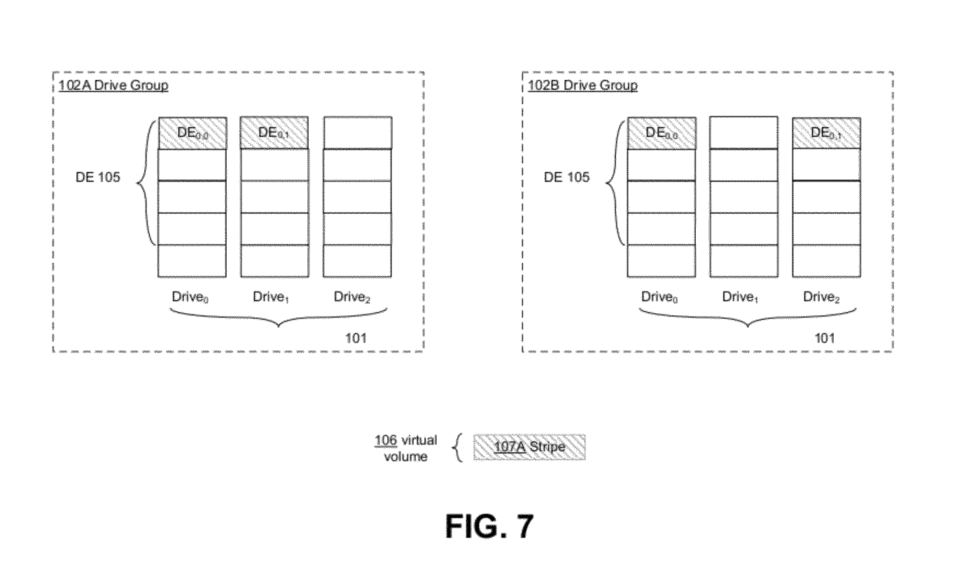

Each drive group 102 may be used to implement one or more virtual volumes 106, such as shown in FIGS. 7-9. A virtual volume 106 may span a portion of a drive group 102, the entirety of the drive group 102, or more than one drive group 102. A client device 104 may define one or more virtual volumes 106 that may be contained in a drive group 102. The virtual volume 106 data may be spread across at least one drive group 102 using a data distribution algorithm. A virtual volume 106 may be created by building stripes through a pseudo-random selection of drives and concatenating those stripes (as described below) until the desired capacity has been obtained. The maximum single virtual volume 106 capacity may be limited only by the free capacity of the drive group 102 in which the virtual volume 106 resides. Every virtual volume 106 may be created as a RAID6 volume, with a fixed drive extent size and a fixed stripe width where the stripe width is less than the number of drives 101.

Referring to FIGS. 7-9, a stripe 107 may be defined as a data set distributed across a given set of drives 101 that makes up one subsection of a virtual volume 106. A stripe 107 may contain one or more drive extents 105 that may be associated with data and parity for the virtual volume 106 (e.g. as configured for RAID6). One or more stripes may be created by selecting a set of drives 101 from all available drives and allocating a drive extent 105 of that drive 101 to a stripe. One or more stripes may then be concatenated to form the virtual volume 106.

To enable stripe and virtual volume creation in a pseudo-random fashion, the I/O controller 103 may maintain a cluster map 108 data structure representing the hierarchical physical and/or logical configurations of a data storage system. The cluster map may be defined by a client device 104 or generated by the I/O controller 103 through detection of attached drives 101.

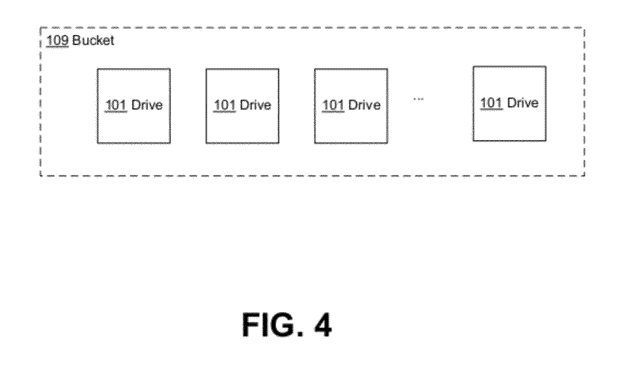

For example, as shown in FIG. 4, a cluster map 108 can be created as a flat pool of storage devices. If the hierarchy is flat there may only be a single bucket 109 that contains all of the drives 101 where every device in the set having an equal available capacity has an equal chance of being chosen.

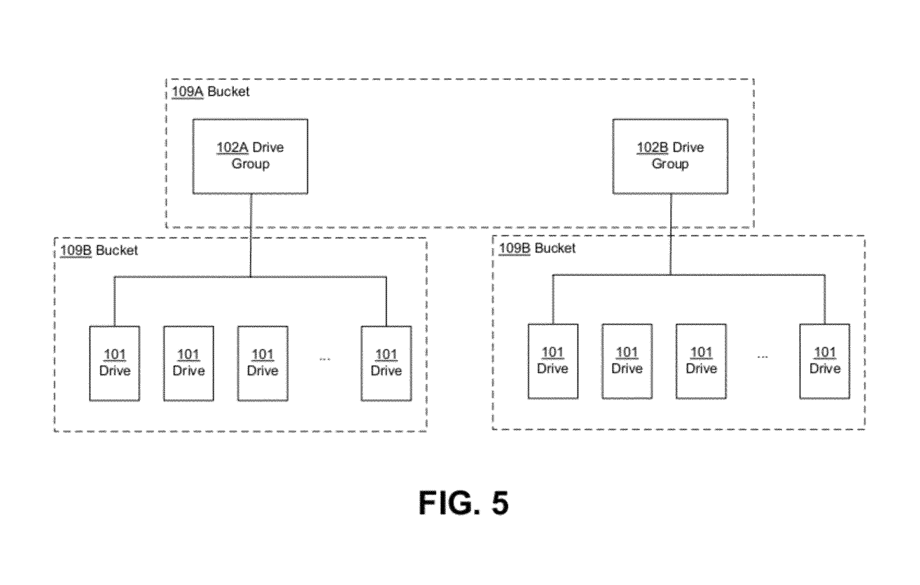

Alternately, as shown in FIG. 5, a cluster map 108 map may be set up in a hierarchical manner. Each layer of the hierarchy may be viewed as a set of “buckets”, where buckets 109 at any layer has similar characteristics. A two-level hierarchy might define a higher level including drive groups 102 and a lower level including individual drives 101.

For example, as shown in FIG. 5, a cluster map for a system with two drive groups 102 each including n drives 101 would consist of three buckets 109. The higher level bucket 109A would contain two objects, which are references to the two drive groups 102. Each of the lower level buckets 1098 would contain n objects, which would be references to the drives 101 associated with each of the drive groups 102.

Each piece of data provided by a client device 104 that is to be placed on the set of storage devices may be assigned a unique identifier 110. The unique identifier 110 may be selection engine 111. For example, the unique identifier 110 may be generated by computing a bitwise OR of a 24-bit shift of the virtual volume number associated with the virtual volume 106 and a next available stripe number (i.e. [virtual volume number <<24] OR [stripeNum]).

Upon receipt of data from a client device 104, the unique identifier 110, the cluster map 108 and a desired stripe width may be provided to a selection engine 111 which may execute a process to define the placement of that data.

The selection engine 111 may provide two pieces of functionality. One is to parse the cluster map hierarchy and apply any associated rules to the appropriate buckets at each level of the hierarchy. The other is to perform a hashing function on each of the buckets to pick an object from the bucket.

The selection engine 111 may traverse the hierarchy of the cluster map 108 from the top to the bottom and apply the rules at each level until the bottom level is reached. The traversal is iterative, such that every path from the highest level to the lowest level is traversed. In the two drive group example of FIG. 5, the hierarchy consists of two levels.

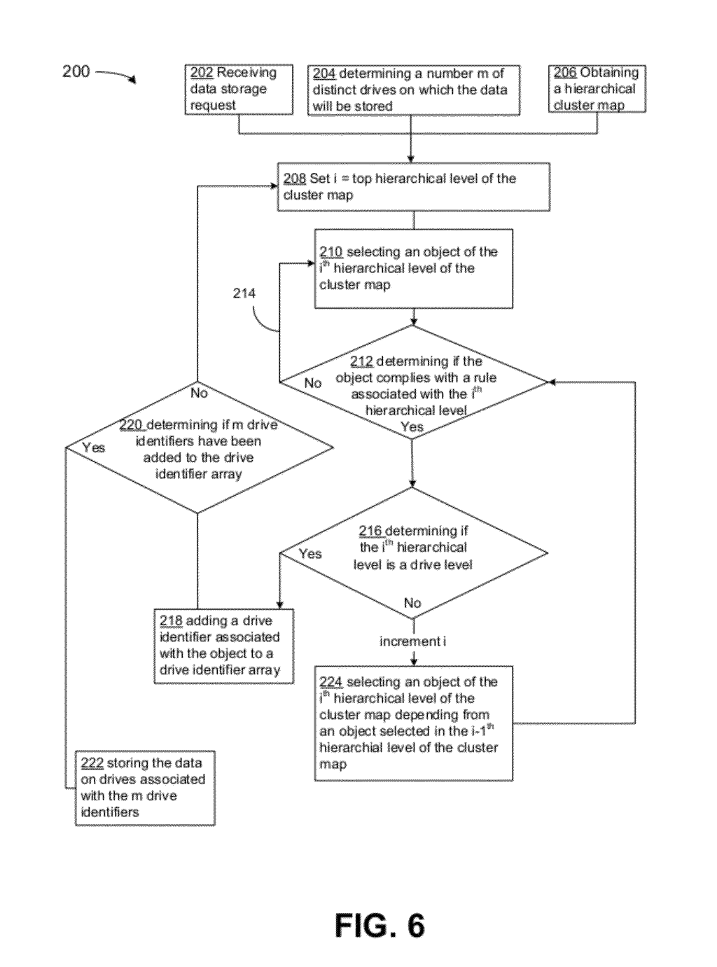

Referring to FIG. 6, a data flow diagram 200 depicting operations of the selection engine 111 are shown. Operation 202 shows receiving a request from a client device to store data on a distributed storage system. For example, as shown in FIG. 2, the I/O controller 103 may receive a write request from a client device 104. The data associated with the write request may be assigned a unique identifier 110.

Operation 204 shows determining a number of distinct drives m to be selected from the n drives in the distributed storage system, wherein m is less than n. For example, the I/O controller 103 may receive a user input from a from a client device 104 indicating a desired stripe width for a stripe 107. Alternately, the I/O controller 103 may maintain a system-specific stripe width for a stripe 107 in memory internal to the I/O controller 103.

Operation 206 shows obtaining a hierarchical cluster map representing the distributed storage system. For example, the I/O controller 103 may receive a user defined cluster map 108 from a client device 104. Alternately, I/O controller 103 may traverse the network of drives 101 in the various drive groups 102 to build a cluster map 108 representative of the storage network. The hierarchy may include various levels. For example, the hierarchy may include various categorizations of objects, but is not limited to various levels of drive groupings (e.g. brick and mortar facilities, rooms, rows, racks, cabinets, etc.) and drives.

Operation 208 shows an initialization of the processing of the cluster map 108 where the processing commences a top level of the cluster map 108. For example, as shown in FIG. 4, the top level will be the drive level. Alternately, as shown in FIG. 5, the top level will be the drive group level.

Operation 210 shows selecting an object at a hierarchical level of the cluster map. For example, the selection engine 111 may employ a hashing function with the unique identifier 110 as a key to select an object at the current hierarchy level. For example, as shown in FIG. 5 the selection engine 111 may select either drive group 102A and drive group 102B.

The hashing function may be similar to those presented in “Hash Functions for Hash Table Lookup” by Robert J. Jenkins Jr., (1995-1997); See http://burtleburtle.net/bob/hash/evahash.html.

Operation 212 shows determining compliance of the object with a hierarchical level rule associated with the hierarchical level. For example, the cluster map may include one or more rules stored in a rules database 112 governing the placement of data across of the set of storage devices. For example, the RAID type for the cluster map might be set up for mirroring. As such, an associated rule may require one drive from each drive group 102 so that the data is spread across power zones. Specifically, the drive group level rule may be to pick two drive groups 102 of the drive group 102 level. The bottom level rule may be to pick two drives 101 from within each drive group 102.

In a specific example, a rule may be to pick 10 drives for an 8+2 RAID6 stripe where two drives are selected from each of five drive groups which would allow for the loss of a drive group (i.e. two drives) while still providing access to the stripe.

In an alternate example, a rule may include weighting parameters. For example, objects within hierarchical levels may be weighted (e.g. drives 101 may be weighted according to their available storage capacity with drives having a higher available storage capacity having greater chance of selection than drives having lower available storage capacity). Specifically, a rule may be to pick only drives having an available storage capacity above a given threshold level until all drives drop below that threshold level at which time all drives may again be available for selection.

Operation 214 shows selecting a second object from the hierarchical level upon a determination of non-compliance with the hierarchical level rule associated with the hierarchical level. If, at operation 212, it is determined that the currently selected object does not comply with a hierarchical level rule (e.g. the object has previously been selected, sufficient objects depending from the object have been previously selected, etc.) an alternate object at the hierarchical level may be selected. For example, as shown in FIG. 5, if a rule states that a drive is to be selected from each drive group and a drive 101 associated with a currently selected drive group 102A has been previously selected, the drive group 102B may be selected for processing to select drives 101 depending from drive group 102B.

Operation 216 shows determining if the hierarchical level is a drive level. As shown in FIGS. 4-5, where a currently selected object is a drive (i.e. the lowest level as designated by the cluster map 108), that drive may be allocated for storage of the data from the client device 104.

Operation 218 shows adding a drive identifier associated with the object to a drive identifier array if the hierarchical level is the drive level. If it is determined at operation 216 that the selected object is a drive, a drive identifier associated with that drive may be added to a drive identifier array 113. As additional drive identifiers may be concatenated to the drive identifier array 113.

Operation 220 shows determining if m drive identifiers have been added to the drive identifier array. As described above, data may be distributed across a set of m unique drives 101 where the number of drives is less than the total number of drives available for storage (i.e. the stripe width is less than the total number of drives). In such a case, drives may be selected until a total number of drive equals m.

Operation 222 shows storing the data on drives associated with the drive identifiers. Once a sufficient number of drives have been selected, the I/O controller 103 may store the client data in drive extents 105 on drives 101 specified by the drive identifier array 113. FIGS. 7-9 show an exemplary progression of storage of data across drives 101 of two drive groups 102 according to a selection of drives 101.

Operation 224 shows selecting a second object at a second hierarchical level below the hierarchical level of the cluster map, the second object depending from the object. If it is determined at operation 216 that the selected object is not a drive (e.g. the object is a drive group), the process may move to a lower hierarchical level where an object at the lower hierarchical level (e.g. a drive) that depends from the previously selected object (e.g. a in a previously selected drive group).

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit a device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into high-level descriptor languages (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational objects, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, transceiver, transmission logic, reception logic, etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those that are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to” or other past-tense adjectives are generally not intended to exclude such variants, unless context dictates otherwise.

Although specific dependencies have been identified in the claims, it is to be noted that all possible combinations of the features of the claims are envisaged in the present application, and therefore the claims are to be interpreted to include all possible multiple dependencies.

What is claimed is:

1. A method for data distribution across a set of n drives of a distributed storage system comprising:
receiving a request from a client device to store data on a distributed storage system;
obtaining a hierarchical cluster map representing the distributed storage system;
selecting an object at a hierarchical level of the cluster map;
determining if the hierarchical level is a drive level; and
adding a drive identifier associated with the object to a drive identifier array if the hierarchical level is the drive level.

2. The method of claim 1, further comprising:
storing the data on drives associated with the drive identifiers.

3. The method of claim 1, further comprising:
selecting a second object at a second hierarchical level below the hierarchical level of the cluster map, the second object depending from the object;
determining if the second hierarchical level is a drive level; and
adding a drive identifier associated with the second object to the drive identifier array if the next lower hierarchical level is the drive level;

4. The method of claim 1, further comprising:
determining compliance of the object with a hierarchical level rule associated with the hierarchical level;

5. The method of claim 5, further comprising:
determining a number of distinct drives m to be selected from the n drives in the distributed storage system, wherein m is less than n;
wherein the determining compliance of the object with a hierarchical level rule associated with the hierarchical level comprises:
determining if m drive identifiers have been added to the drive identifier array.

6. The method of claim 1, further comprising:
selecting a second object from the hierarchical level upon a determination of non-compliance with the hierarchical level rule associated with the hierarchical level.

7. A system for data distribution across a set of n drives of a distributed storage system comprising:
means for receiving a request from a client device to store data on a distributed storage system;
means for obtaining a hierarchical cluster map representing the distributed storage system;
means for selecting an object at a hierarchical level of the cluster map;
means for determining if the hierarchical level is a drive level; and
means for adding a drive identifier associated with the object to a drive identifier array if the hierarchical level is the drive level.

8. The system of claim 7, further comprising:
means for storing the data on drives associated with the drive identifiers.

9. The system of claim 7, further comprising:
means for selecting a second object at a second hierarchical level below the hierarchical level of the cluster map, the second object depending from the object;
means for determining if the second hierarchical level is a drive level; and
means for adding a drive identifier associated with the second object to the drive identifier array if the next lower hierarchical level is the drive level;

10. The system of claim 7, further comprising:
means for determining compliance of the object with a hierarchical level rule associated with the hierarchical level;

11. The system of claim 10, further comprising:
means for determining a number of distinct drives m to be selected from the n drives in the distributed storage system, wherein m is less than n;
wherein the means for determining compliance of the object with a hierarchical level rule associated with the hierarchical level comprises:
means for determining if m drive identifiers have been added to the drive identifier array.

12. The system of claim 7, further comprising:
means for selecting a second object from the hierarchical level upon a determination of non-compliance with the hierarchical level rule associated with the hierarchical level.

13. A computer readable medium including computer-readable instructions for execution of a process, the process comprising:
receiving a request from a client device to store data on a distributed storage system;
obtaining a hierarchical cluster map representing the distributed storage system;
selecting an object at a hierarchical level of the cluster map;
determining if the hierarchical level is a drive level; and
adding a drive identifier associated with the object to a drive identifier array if the hierarchical level is the drive level.

14. The system of claim 7, the process further comprising:
storing the data on drives associated with the drive identifiers.

15. The system of claim 13, the process further comprising:
selecting a second object at a second hierarchical level below the hierarchical level of the cluster map, the second object depending from the object;
determining if the second hierarchical level is a drive level; and
adding a drive identifier associated with the second object to the drive identifier array if the next lower hierarchical level is the drive level;

16. The system of claim 13, the process further comprising:
determining compliance of the object with a hierarchical level rule associated with the hierarchical level;

17. The system of claim 16, the process further comprising:
determining a number of distinct drives m to be selected from the n drives in the distributed storage system, wherein m is less than n;
wherein the determining compliance of the object with a hierarchical level rule associated with the hierarchical level comprises:
determining if m drive identifiers have been added to the drive identifier array.

18. The system of claim 13, the process further comprising:
selecting a second object from the hierarchical level upon a determination of non-compliance with the hierarchical level rule associated with the hierarchical level.
